(19) United States
(12) Patent Application Publication
(10) Pub. No.: US 2016/0117944 A1
(43) Pub. Date: Apr. 28, 2016

(54) System and Method for Evaluating Experiment Teaching Achievement

(71) Applicant: Qingdao University, Qingdao (CN)

(72) Inventors: Xiquan Sun, Qingdao (CN); Xiaodong Zhang, Qingdao (CN); Xiaodong Li, Qingdao (CN); Yandong Wei, Qingdao (CN)

(73) Assignee: Qingdao University

(21) Appl. No.: 14/986,628

(22) Filed: Jan. 1, 2016

Related U.S. Application Data
(63) Continuation of application No. PCT/CN2014/081500, filed on Jul. 2, 2014.

(30) Foreign Application Priority Data
Jul. 3, 2013 (CN) 201310276897.6

(51) Int. Cl. G09B 7/02; G09B 19/00

(52) U.S. Cl. CPC G09B 7/02; G09B 19/00

(57) ABSTRACT

Provided are a performance evaluation system and method for laboratory leaning, relating to the field of education management and evaluation, in particular a performance evaluation system and method for laboratory learning for students using glass equipment as laboratory equipment. The present invention takes into consideration the shortcomings of the current performance evaluation method for laboratory learning and provides a performance evaluation system and method for laboratory learning that include an attendance statistics module, a monitoring module, an equipment management module, a laboratory data image recognition module, a laboratory data input interface module, a laboratory sample testing module, a laboratory data processing and analysis module, a laboratory knowledge computer written exam module, a student interface module, a teacher interface module, and a central processing module. The current broad observation-based student evaluation is replaced with precise evaluation based on measured student data, thereby substantially enhancing the precision of the student evaluation, and effectively lowering the working intensity of the laboratory teachers.

### CROSS-REFERENCE TO RELATED APPLICATIONS

This application is a continuation of International Patent Application No. PCT/CN2014/081500 with an international filing date of Jul. 2, 2014, designating the United States, now pending, and further claims priority benefits to Chinese Patent Application No. 201310276897.6 filed Jul. 3, 2013. The contents of all of the aforementioned applications, including any, intervening amendments thereto, are incorporated herein by reference.

### TECHNICAL FIELD

The present invention relates to a system and method for evaluating experiment teaching achievement, belongs to the field of teaching management and evaluation, and more particularly to a system and method for evaluating experiment teaching achievement based on an automatic identification technology.

### BACKGROUND

Science needs equal attention to theory and practice, and related experiments shall be conducted while in theoretical study. With the continuous intensification of teaching reformation, experimental course's status in teaching is continuously enhanced. Experiment teaching has an irreplaceable role in developing students' innovative consciousness, manipulative ability, the abilities of analyzing and solving problems, etc.

The evaluation of student achievement in the experimental course is a correct evaluation of students' experimental knowledge and skill level and also objectively reflects the experiment teaching effect, so it becomes an important means of understanding the teaching effect and improving the teaching method for teachers.

Generally speaking, the evaluation of student achievement in the experimental course comprises several achievements like attendance information, operation evaluation, original data authenticity affirmation, experimental report evaluation, etc.

Attendance information can be determined by many modes, e.g., signing on an attendance form by students, calling the roll by the teachers according to students' name list, using an identification card with student information to punch card, using a fingerprint reader for discriminating identities, etc. Attendance information is the basis of evaluating other achievements. The check of attendance can be used for finding violations of absenteeism, lateness, early leaving, replacement, etc. to ensure that the students consistently finish the entire experiment. However, the statistics of the normal attendance will be influenced by replacing other students to sign on the attendance, replacing other students to answer the teacher when the teacher calls the roll according to the students' name list, replacing other students to punch cards when using the identification card with student information to punch the cards, etc.

Operation evaluation is made by the teachers through patrol in the process of the experiment and observation of students' operation so as to evaluate the achievement of this part. The teachers have an evaluation according to correctness, normalization and proficiency of students' experimental operation, accurate mastery of experimental flow, post-experiment cleaning, collation, etc. Operation evaluation is finished subjectively by experimental instructors. The experimental instructors need to continuously patrol and observe to find various problems of the students in operation. If the experimental instructors cannot frequently patrol or find the problems in time, the students' experimental achievement cannot be comprehensively and accurately evaluated.

The students will obtain all kinds of original data in the experiment and will obtain the experimental result after processing the data. For various purposes, the students will plagiarize or fabricate original data. One reason is that the experimental result is an important composition of ultimately evaluating student achievement. To obtain better achievement, some students modify real original data into the data for obtaining higher achievement. This modification of the real data may occur after the students just obtain the original data or in the process of writing the experimental report. Under this condition, the experimental instructors now adopt the mode of signing on the original data to ensure that the students cannot modify the data in the process of writing the experimental report, but cannot prevent the students from modifying the data just after obtaining the original data. The other reason is that some students use the time gap of the patrol of the experimental instructors to plagiarize or fabricate the data without performing an experiment. In case of plagiarizing the data, the experimental instructors identify plagiarism mainly through memory, but objectively speaking, the discovery rate of plagiarism is very low. In addition, Lin Jie and Wu Zhengfan mention a computer-based discrimination system for plagiarism of experimental report in Construction of Experimental Platform and Teaching Reformation for Preventing Plagiarism of Experimental Report in which the entire experimental report is submitted to the computer for comparing the similarity, but do not clearly mention the comparison situation of the original data. In case of fabricating the data, the experimental instructors can only judge and discriminate from individual data that obviously does not conform to the experimental result that whether the data belongs to the fabricated data, but do not have any methods to discriminate the fabricated data that conforms to the experimental law. It is observed from the above analysis that it is difficult to ensure the authenticity of the original data by the existing measure, so the affirmation of the authenticity of the original data is an obvious weakness for achievement evaluation of the whole student experimental course.

Now there are two modes for evaluating accuracy and precision of the experimental data and correctness of the experimental data processing procedure: the first one is that the experimental instructors calculate and compare their results with the calculation result of the students when finding a doubtful point in reviewing the experimental report based on many years of experience of reviewing the experimental report; and the other one is that the data is inputted into a computer, processed according to a correct processing method and compared with the calculation result of the students.

The evaluation of the experimental report also comprises the evaluation of the integrity of the entire experimental report, correctness of experimental conclusion, etc.

Although the evaluation of the experimental achievement shall contain the above contents, because of larger workload of the experimental instructors and difficulty in objectively, comprehensively, fully and accurately recording operation evaluation, affirmation of authenticity of the original data, etc., the existing experimental achievement is mainly determined by attendance and the experimental report and the experimental levels of the students cannot be comprehensively reflected.

In addition, the existing evaluation of the experimental achievement mainly comes from the individual evaluation achievement of the experimental teachers. The strong individual subjectivity of teachers during evaluation leads to the strong individual subjectivity of experimental achievement, so that the experimental truth of the students cannot be reflected without corresponding objective evaluation.

On the other hand, because low-value easy-consumption instruments used in the experiment have the defects of large quantity, easy loss, quick damage and low price, the informationization management cannot be realized. When there are many operating personnel in a laboratory to simultaneously work, experimental instruments may be mixed, causing it difficult to distinguish the responsibilities for loss and damage of the experimental instruments. This is especially apparent in the experiment of the students. The students are admitted to the student laboratory to perform the experiment in different periods of time each year. Each laboratory often circularly admits students in multiple classes to perform the experiment. The experimental instruments on an experimental platform are also used jointly by each class. But because basic operating training is mostly conducted by the students and the students are not skilled in experimental operation, the experimental instruments are frequently mixed, lost and damaged. In order not to influence the experiment, the lost and damaged experimental instruments shall be supplemented in time and compensated by responsible persons. However, because there are many experimental instruments with the same specification, it is very difficult to confirm the persons responsible for mixing, loss and damage of the instruments.

The existing common management methods are that: 1. The students individually use a set of experimental instruments. When entering the laboratory, the students check and confirm to receive the full set of instruments. After all the experiments are finished, all the instruments are returned to the laboratory. If the instruments are lost or damaged, it will be treated according to the laboratory rule. 2. Many students alternately share one set of experimental instruments. Each student checks and confirms to receive the full set of instruments before the experiment. Instruments lost or damaged shall be reported to the teachers in time for registration and supplementation. After the experiment, the full set of instruments is checked. The instruments lost or damaged shall be reported to the teachers in time for registration and supplementation. After this, the above work is repeated for each experiment.

These management methods also have problems in actual operation. For example, after the students finish the experiment, they do not carefully check the experimental instruments and do not find that some instruments are damaged or lost. When the students finish the experiment and check the experimental instruments, the instruments are not damaged and lost, but the instruments are taken away or damaged by other classmates after the students leave the laboratory. Both of the situations will cause that the classmates of the next class find that the experimental instruments are reduced or damaged during check, but the classmates of the previous class believe that they clearly check the instruments at the end of the experiment and consider that the compensation is unreasonable. The solution to this is that the instructors check and confirm each set of experimental instruments for completeness in person at the end of the experiment of each student, which greatly increases the workload of the teachers and the students. These methods belong to manual operation management and have the defects of complicated operation, large labor intensity of the teachers, low management efficiency, serious compensatory hysteresis etc.

There are now many computer systems related to laboratory management and assessment of student experiment level. For example:

Chinese Invention Patent Application No. 201210161009.1 discloses a comprehensive management system for a laboratory, comprising a computer and comprehensive management software of the laboratory, wherein the comprehensive management software of the laboratory is installed in the computer; the comprehensive management software of the laboratory comprises a portal website construction module, a laboratory information management module, a basic data setting module, a laboratory instrument device management module, a laboratory material consumable management module and a laboratory monitoring module, but the application does not mention how the modules are concretely operated.

Chinese Invention Patent Application No. 201010237740.9 provides a remote automatic correcting method for circuital virtual experiment, which comprises: parsing an inputted experimental script of standard answer to obtain a collection of instrument device scoring points and a collection of circuit connection scoring points; selecting needed scoring points from the collection of scoring points, setting a score corresponding to each scoring point, this scoring point will become a scoring rule and a scoring rule library is formed by many scoring rules after the setting is finished; parsing the virtual experiment script to be corrected into an instrument device object and an instrument port object and converting the instrument device object and the instrument port object into factual data; judging whether the factual data is matched with the scoring rules in the scoring rule library, and recording a matching result of each scoring rule in the matching process; and accumulating the scores of the scoring rules successfully matched to obtain the aggregate score in the experiment correction, and outputting the matching results and the score as a school report after correction. The application is applicable to the circuital virtual experiment.

Chinese Invention Patent Application No. 201010288585.3 relates to a system and method therefor for evaluating experiment based on a wireless personal digital assistant and a database, characterized in that the system comprises a background server, a wireless router, a card-swiping subsystem and a client which consists of a local area network PC, a plurality of campus network PCs and a wireless personal digital assistant, wherein the background server, the local area network PC, the card-swiping PC and the wireless router are connected to an experiment center local area network; an IC card reader-writer is connected to the card-swiping PC through a USB interface; the campus network PCs are connected with a campus network; and the experiment center local area network is connected with the campus network. The method comprises the steps of: swiping the cards by the students, logging in WWW server, inquiring student information, selecting students and experimental projects, inquiring evaluation standard information, evaluating the experiment, etc.

With respect to the above problems, the present invention proposes a system and method for evaluating experiment teaching achievement based on automatic identification technology. In the system and the method for evaluating the experiment teaching achievement of the students, an identity identification technology is used for transferring each link in the process of the experiment to the students for completion in self-service mode; and the existing extensive observation and evaluation of the students is converted into precise evaluation based on quantitative data of the students themselves, thereby obviously enhancing the accuracy of student evaluation and effectively reducing the labor intensity of the experiment teachers.

### SUMMARY OF THE INVENTION

1. A system and method for evaluating experiment teaching achievement based on automatic identification technology, characterized in that:

The system comprises an attendance statistic module, a monitoring module which includes a video monitoring sub-module and a mobile monitoring sub-module, an instrument management module, an experimental data and image identification module, an experimental data input interface module, an experimental test sample module, an experimental data processing and analysis module, an computer written test module of experimental knowledge, a student interface module, a teacher interface module, a central processing module and the like.

The attendance statistic module is used to provide the attendance information of students to the central processing module.

Experimental instructors will provide students' experimental conditions found by the video monitoring sub-module to the central processing module.

By the mobile monitoring sub-module, experimental instructors will provide students' relevant conditions found in patrol to the central processing module.

The instrument management module is used to provide relevant instrument condition records including usage, loss, damage, compensation and so on to the central processing module.

The experimental data and image identification module is used to identify students' original data in image identification way and provide these information to the experimental data processing and analysis module and the central processing module.

The experimental data input interface module is used to receive students' experimental data transmitted by the experimental instrument data communication interface, and then provide these information to the experimental data processing and analysis module and the central processing module.

The experimental test sample module is used to manage test samples and relevant information, record sample allocation and provide students' sample information to the experimental data processing and analysis module and the central processing module;

The experimental data processing and analysis module is used to analyze and process the students' experimental original data identified in image identification way, students' experimental data transmitted from the experimental instrument data output interface, the test sample information provided by the experimental test sample module, experimental data read by the students themselves and calculating results, and provides related conditions of the experimental data of the students to the central processing module.

The computer written test module of experimental knowledge is used to test students about experimental knowledge by computer exam system, and then provide exam results to the central processing module.

Experimental instructors can mark students' experimental reports, and then provide students' scores to the central processing module through the teacher interface module.

Students can input experimental data and results analyzed and calculated by the students themselves through the interface module, and can also browse their experiment scores, deduction, compensation records of experimental instruments and related information. Students need to participate in experimental knowledge examination by the student interface module.

Class management personnel such as monitor and instruments manager can browse and manage cleaning duties, laboratory discipline, instruments compensation and other related information.

The central processing module stores a variety of information required for normal operation of each module like the attendance statistic module, the monitoring module, instrument management module, the experimental data and image identification module, the experimental data input interface module, the experimental test sample module, the experimental data processing and analysis module, the computer written examination module of experimental knowledge, the student interface module and the teacher interface module, and provides the required information to each module.

The central processing module converts the received attendance information of experimental students, students' experimental situations found by the video monitoring sub-module, students' related situations found by the mobile monitoring sub-module during patrol, experimental instrument related situations, the overall situation of students' experimental data, students experimental knowledge test achievement and experimental report results reviewed by the experimental instructors into the corresponding attendance achievement, video achievement, patrol achievement, instrument achievement, data achievement, examination achievement and report achievement in accordance with pre-established criteria.

The final experiment scores of students are obtained by weighted adding attendance scores, performance scores, video scores, patrol scores, instrument scores, data scores, exam scores and report scores according to the predetermined methods.

2. The system and method for evaluating experiment teaching achievement based on automatic identification technology according to claim 1, characterized in that:

The central processing module stores

laboratory information like laboratory name, laboratory type, laboratory location, teachers responsible for laboratory etc.

teacher information like teachers' names and positions, etc.

experimental device information like device name, number, model, specifications, use, price, purchase date, manufacturer, belonging laboratory and responsible teachers, etc.

experimental instrument information like experimental instrument names, bar codes, model, specifications, price, manufacturer, etc.

data like objective question database and related test data,

student name, student number, department, major and other student information

experimental course name, experimental project, experiment lab name, experiment time, name list of students, experimental instructor, student experimental operation table location and other teaching information

test samples information,

student achievement information

The central processing module is responsible for storing these information and distributing these data to those which need corresponding information like the attendance statistic module, the monitoring module, the instrument management module, the experimental data and image identification module, the experimental data input interface module, the experimental test sample module, the experimental data processing and analysis module, the computer written examination module of experimental knowledge, the student interface module and the teacher interface module.

The central processing module is the core part of the whole evaluation system, which is controlled by teachers and the computer is used as the carrier. The central processing module need to store information and the information are needed to be entered into central processing module before experiment. Besides, it can also be used for information processing. Teachers can add or delete information stored in the central processing module through the backstage management software.

3. The system and method for evaluating experiment teaching achievement based on automatic identification technology according to claim 1, characterized in that:

The automatic identification technology includes bar code technology, two-dimension code technology, magnetic stripe technology, IC card technology, radio-frequency technology, biological feature identification technology and so on;

During experiment teaching, each student, experimental instrument, and test sample will be given a combined code based on automatic identification technology. Through combined code reading devices, combined code can be identified each experimental student, experimental instrument and test sample. Besides, students can also be identified by biological characteristics;

Wherein the feature combined code can use bar code, two-dimensional code, magnetic stripe, IC card or radio-frequency chip as carriers,

Correspondingly, combined code reading devices are bar code scanner, two-dimensional code scanner, magnetic stripe reader, IC card reader, radio-frequency label reader and so on;

More specifically,

Students can use any one kind of bar code technology, two-dimensional code technology, magnetic stripe technology, IC card technology, radio-frequency technology, biological feature identification technology to be identified;

Bar codes are used to identify experimental instruments;

Test samples can use any one kind of bar code technology, two-dimensional code technology, magnetic stripe technology, IC card technology or radio-frequency technology to be identified.

4. The system and method for evaluating experiment teaching achievement based on automatic identification technology according to claim 1, characterized in that:

Wherein the attendance statistic module uses one or more kinds of fingerprint identification technology, face identification technology, iris identification technology, retina identification technique, corneal identification technology, voice identification technology to identify students;

Wherein the attendance statistic module is used to memorize feature identification information of each student at first, such as fingerprint, face, iris, retina, cornea, voice and so on, then establish unique association of these feature identification information and students' identity;

Students need to input feature identification information at the beginning and the end of the experiment, and the attendance statistic module compares the time of inputting the feature identification information by the students during the experiment with the time required by the experiment to confirm whether the students are late, leaving early or absent, and provides the identified result to a central processing module.

5. The system and method for evaluating experiment teaching achievement based on automatic identification technology according to claim 1, characterized in that:

Wherein the monitoring module comprises video monitoring sub-module and the mobile monitoring sub-module

Wherein the video monitoring sub-module comprises an audio and video collecting device and an audio output device installed in the laboratory, a video display device and an audio input and output device installed in the monitoring room and corresponding software;

The experimental instructors observe student experimental operating situation through video display. Besides, they can observe laboratory overall situation to find whether students violate provisions of the laboratory through the video collecting device installed in the experimental platform. Through the video collecting device installed in the experimental platform or platform extension line, teachers can observe whether the operation of students is correct. And experiment instructors can observe whether the use of public instruments and taking public reagent operation are correct through monitoring video devices installed in the public instrument operation area and reagent supply area;

Experimental instructors can point out students' problems in experiment through the audio output device in the laboratory, and provide problems found in experiment to the central processing module;

Through the video monitoring, teachers can timely and appropriately correct students' operation errors during experiment, and evaluate students' operation skills. In addition, the video monitoring can make students do experiment more carefully, and if some instruments are damaged, it can also trace to the responsible person in time. In order to complete this operation evaluation, the position of the experimental operating desk of each student needs to be fixed. When all the students finish filling their experiment position information in a sheet, teachers will count and input the information into the central processing module for recording. Video collecting devices like camera need to be installed in the laboratory, and connected to the central processing module.

There are two kinds of video collecting, devices. One is used to observe the laboratory overall situation, mainly for observing whether violations of laboratory provisions, such as slapstick, exist in the laboratory. The other is installed in the position where student operation can be observed, mainly used for observing whether the student operation is correct. For this kind of camera, it can be installed on extension lines of each row of experimental platforms for monitoring the operation of this row of students or installed in a public instrument operation region and a public reagent taking region for monitoring the operation of the students in the public region.

The video monitoring sub-module can store videos shot by the cameras for a period of time, and has inquiry functions like playback and evidence fixing function like image interception.

The mobile monitoring sub-module is installed in the smart phone, storing lab name, experimental course name, experimental project, experimental time, studentr name and ID according to major and class, experimental instructors and other information; options like types of student operation error and types of violations of laboratory provisions are arranged in the mobile monitoring sub-module.

When teachers find students operation error or violations of laboratory provisions in the patrol during experiment, student's name and ID are confirmed in the mobile monitoring sub-module at first, and corresponding options like types of student operation error and types of violations of laboratory provisions are chose to identify. Finally, the mobile monitoring sub-module provides the identification of types of student operation error and types of violations of laboratory provisions to the central processing module by wireless way.

After laboratory cleaning, experimental instructors check sanitation situation and deduct marks for those students on duty who fail to meet cleaning requirements, and then provide related information to the central processing module.

Violations of laboratory provisions include but not limited to laboratory safety management provision, sanitary control provision and the like.

6. The system and method for evaluating experiment teaching achievement based on automatic identification technology according to claim 1, characterized in that:

The instrument management module is responsible for the statistics of instrument usage, loss, damage, compensation, and provides related information to the central processing module.

The hardware of the instrument management module includes a bar code scanner and experimental instruments with bar codes. The bar code on each experimental instrument is not the same;

Before experimental course, students will initially confirm whether the instruments is in good condition, then scan bar codes on the instruments into database, so information that the student is responsible for the instrument is stored into the database. Students scan bar codes on their responsible experiment instruments before each experiment and compared with information in the database in order to confirm experiment instruments are in good condition;

If students find instrument instrument is damaged in inspection at the beginning of the experiment, they need to scan damaged instrument bar code and provide it to the central processing module, damaged instruments should be stored into damaged instrument area; an experimental instrument manager will open the storage position of a new instrument and lead the students to get a new instrument of same type from experimental instrument manager and scan the new bar code to update database; then the experimental instrument manager will identify students who damage the instrument by evidences like experiment arrangement and video monitoring, and inform the related student to compensate by the student interface module.

If the students check and find that the experimental instruments that do not belong to their responsible instruments appear in storage positions of their responsible experimental instruments at the beginning of the experiment, they can confirm the responsible students of the experimental instruments through the bar codes on the experimental instruments and return the misplaced experimental instruments to the related students.

If the students check and find that some of their responsible experimental instruments are missing at the beginning of the experiment compared with their responsible experimental instruments in the information database, they need to wait for other students to scan the bar codes of the experimental instruments and ask whether they find the missing experimental instruments. If the missing experimental instruments are found, the students get them back; and if the missing experimental instruments are not found, the students should provide the bar code information of the missing instruments to the central processing module. Then an experimental instrument manager will open the storage position of a new instrument and lead the students to receive a same type new instrument, scan the bar code of the new instrument for registration and update the information database of the student instrument; after that, the experimental instrument manager confirms the students who damage the instrument according to the experimental information like experimental arrangement and the evidence like video monitoring and notifies the students who damage the instrument in the student interface module to do compensation.

If the students damage the experimental instrument in the experiment, they need to scan and provide the bar code information of the damaged instruments to the central processing module and store the damaged instrument to the damaged instrument area; the experimental instrument manager will open the storage position of a new instrument and lead the students to get a new instrument of same type, scan the bar code of the new instrument for registration and update the information database of the student instrument; after that, the experimental instrument manager confirms the students who damage the instrument and notifies the students who damage the instrument in the student interface module to do compensation.

If the students damage the experimental instrument and the bar code at the same time, they need to manually input the information related to the instrument, provide the information of the damaged instrument to the central processing module and store the damaged instrument to the damaged instrument area. The experimental instrument manager will open the storage position of a new instrument and lead the students to get a new instrument of same type, scan the bar code of the new iinstrument for registration and update the information database of the student instrument; after that, the experimental instrument manager confirms the students who damage the instrument and notifies the students who damage the instrument in the student interface module to do compensation.

After the experiment, the students need to put their responsible experimental instruments on normal storing areas, and scan the bar codes again in order to confirm that their responsible experimental instruments are not missing and misplaced.

The instrument management module automatically calculates out the compensation amount of each student as damage of the experimental instruments and sends the compensation amount to the central processing module. The central processing module sends the amount information to be compensated for each student due to damage of the experimental instruments to the student interface module of the students, and meanwhile makes a copy for the experimental instrument manager of the class of the student. Finally, the experimental instrument manager of the class should collect all the compensation fees of the experimental instruments of the whole experimental class and turn over money to experimental instructors.

If the damage of the experimental instrument is found by the students themselves and the students actively compensate for them, compensation ratio can be reduced according to the circumstances; and if the damage of the experimental instrument is found by the next experiment classmates, the students who damage the experimental instrument need to pay for them as a high compensation ratio.

7. The system and method for evaluating experiment teaching achievement based on automatic identification technology according to claim 1, characterized in that:

The experimental data and image identification module comprises an image collecting device, an image transmission device and image identification software;

After reading the original data of the experiment, the students use the image collecting device to shoot an image of the original data of the experiment and then use the image transmission device to transmit the data to the image identification software. The image identification software reads and provides the original data of the experiment in the image by an image identification method to the experimental data processing and analysis module and the central processing module.

The original data of the experiment read by the image identification way is compared with students' experimental data and analyzed so as to inspect whether students' original data of the experiment is real and prevent the students from modifying the original data or plagiarizing others' data.

The experimental data input interface module receives students' experimental data transmitted by the experimental instrument data communication interface, and then provides the data to the experimental data processing and analysis module and the central processing module. For example, an electronic balance is essentially equipped with an RS232 data communication interface. The experimental data of the students can be directly transmitted from the electronic balance. The experimental data input interface module receives student weighing data transmitted from the data communication interface of the electronic balance and provides the same to the central processing module.

8. The system and method for evaluating experiment teaching achievement based on automatic identification technology according to claim 1, characterized in that:

The experimental test sample module comprises a test sample, a test sample information database etc.

Each experiment has 2 to 15 test samples which have significant difference in measured quantitative characteristics.

Each test sample is made into an independently packed test sample applicable to each student or experimental group, and an information carrier in which feature combined codes are stored is adhered to the test sample or the package of the test sample. The quantitative characteristic value of each test sample and the corresponding feature combined code information are inputted into a sample information database and associated.

The students get test samples before the experiment and scan the received carrier in which the feature combined code information is stored on the test samples through a feature combined code information reading device. The feature combined code information reading device sends the scanned feature combined code information of the test samples to the experimental test sample module.

After receiving the feature combined code information about the test samples sent by students, the experimental test sample module finds the corresponding measured characteristic of the feature combined code information in the test sample information database, associates the students with the standard values of the measured quantitative characteristics of the received test samples, and then sends the conditions to the experimental data processing and analysis module and the central processing module.

The measured characteristics can be some quantitative nature of the test sample to be measured and determined in the experiment, such as chemical property. In an analytical chemistry experiment “Determination of Molar Mass of Organic Acid” provides two organic acids of different molar masses, i.e., oxalic acid and citric acid. Another example is that in physical chemistry experiment “Determination of Molecular Weight by Cryoscopic Method” provides two kinds of materials to be tested of different molecular weights, i.e., naphthalene and anthracene. In addition, the measured characteristics can also be such physical property as acoustics, optics, thermotics, magnetics, electrics, etc. These examples are only for bettering understanding, but not for limiting the scope of the measured characteristics.

The test samples can be self-made or purchased; whatever the sources are, the measured characteristics of different test samples in the same laboratory shall have significant differences. For example, in the test sample provided in the experiment of “Determination of Contents of Sodium Carbonate and Sodium Hydroxide in Mixed Alkali”, the mass percentage of the sodium hydroxide and the mass percentage of the sodium carbonate in the mixed alkali test sample of the sodium hydroxide and the sodium carbonate are different. After such test samples are distributed randomly to the students, the students cannot determine their test samples belong to which kind of test samples and cannot know the possible contents of the test samples. Therefore, the students can not plagiarize the data from other students or fabricate the data, so they should determine seriously by themselves. The practice enhances the teaching quality and effect. There is similar practice in laboratories for providing test samples before, but currently the combination of the practice with automatic identification technology has not been reported,

9. The system and method for evaluating experiment teaching achievement based on automatic identification technology according to claim 1, characterized in that:

The experimental data processing and analysis module receives students' experimental original data identified in an image identification way, students' experimental data transmitted from the experimental instrument data output interface, the test sample information provided by the experimental test sample module, experimental data read by the students themselves and calculating results.

The experimental data processing and analysis module compares the received students' experimental original data identified in the image identification way, students' experimental data transmitted from the experimental instrument data output interface and the experimental data read by the students themselves to evaluate the accurate situation of reading the original data by the students.

The experimental data processing and analysis module compares the received test sample information provided by the experimental test sample module with the calculation result of the students to evaluate the accurate situation of the test results of the students.

The experimental data processing and analysis module integrates the accurate situation of reading the original data by the students and the accurate situation of the test results of the students and forms the entire situation of the experimental data of the students and provides the same to the central processing module.

The experimental data processing and analysis module analyzes the accuracy or/and precision of the students' experimental original data identified in the image identification way, students' experimental data transmitted from the experimental instrument data output interface and the experimental data read by the students themselves in accordance with the data processing and analysis requirements of an experiment teaching material, and provides the accuracy or/and precision analysis result to the central processing module.

The experimental data processing and analysis module needs to perform analysis according to experimental principles and required experimental results of different experiments and can use data processing software such as Excel or self-written program, etc. to form a “data processor” for processing the experimental data of the students.

10. The system and method for evaluating experiment teaching achievement based on automatic identification technology according to claim 1, characterized in that:

The computer written test module of experimental knowledge tests the students about experimental knowledge by the computer exam system, and then provides exam results to the central processing module.

The computer written test module of experimental knowledge comprises an objective question examination database of each experimental course that comprises choice questions and true or false questions provided in the laboratory.

The students enter the computer written test module of experimental knowledge through the student interface module. The computer written test module of experimental knowledge randomly extracts examination questions from the objective question examination database of the experimental course of the students to form examination paper provided to the examination students. The examination students answer the examination paper. The computer written test module of experimental knowledge receives the answers of the examination students and compares the same with standard answers, and then provides the answering information of the examination students to the central processing module.

The computer written test module of experimental knowledge can test the entire mastering condition of the students for the experimental knowledge.

The experimental report achievement is reviewed by the teacher. The teacher can give the students fair and reasonable experimental report achievement according to students' preview condition, writing standardized degree, serious degree, etc. with combination of the teacher's teaching experience, and then inputs the achievement into the central processing module.

The method and the system for evaluating experiment teaching achievement provided by the present invention consider various conditions of evaluation of experiment achievement and change inability to monitor manually or inability to comprehensively monitor into ability of monitoring using a computer, which obviously enhance evaluation accuracy and objectivity and improve the defect of excessive subjectivity of achievement evaluation.

The method and the system for evaluating experiment teaching achievement provided by the present invention greatly enhance serious degree and devotion degree of the students in the experiment, urge the students to responsibly finish the experiment and enhance students' experimental ability and level.

The method and the system for evaluating experiment teaching achievement provided by the present invention greatly reduce the labor intensity of the experimental instructors and increase the working efficiency of the experimental instructors.

### DETAILED DESCRIPTION OF PREFERRED EMBODIMENTS

The application of the present invention provides a concrete embodiment by taking an analytical chemistry laboratory as an example.

The chemistry laboratory provides about 700 students of 22 classes majoring in seven-year clinical medicine, five-year clinical medicine, stomatology, inspection, prevention, nursing, etc. in medical college with Basic Chemistry Experimental course and about 90 students of 3 classes majoring in chemistry in Chemical Engineering Institute with the experimental course of Science Analytical Chemistry Experiment in the autumn term in September each year, and provides about 450 students of 15 classes majoring in material, compound material, light chemical engineering, applied chemistry and chemical engineering in Chemical Engineering Institute with the experimental course of Engineering Analytical Chemistry Experiment and provides about 30 students majoring in pharmacy of medical college with Medical Analytical Chemistry Experimental course. The laboratory has three rooms for the experiment for the students (each can accommodate 30 students for the experiment), two balance rooms, one storehouse and one ready room for the experiment.

The system for evaluating experimental course achievement of the students of the chemical laboratory comprises an attendance statistic module, a monitoring module, an instrument management module, an experimental data and image identification module, an experimental data input interface module, an experimental test sample module, an experimental data processing and analysis module, an computer written test module of experimental knowledge, a student interface module, a teacher interface module, a central processing module and the like.

The central processing module has an interactive interface with the above modules, can obtain information from the above modules and can also send the information stored in the central processing module to each module.

Laboratory information like the laboratory name of the chemical laboratory, the laboratory type (i.e., basic chemistry laboratory), room numbers of three laboratories, responsible teachers for the laboratories etc., teacher information like names and posts of responsible teachers for the laboratories, etc., experimental device information like device name, device number, model, specification, device purpose, price, purchase date, manufacturer, laboratory of device, responsible teachers, etc., experimental instrument information like experimental instrument name, instrument bar code, model, specification, price, manufacturer, etc., and data like information of objective question examination base are stored in the system for evaluating experimental course achievement of the students of the chemical laboratory.

The achievement information of the students who have finished the experiment is stored in the system for evaluating experimental course achievement of the students.

The experimental instruments have bar codes with unique numbers. In other words, each experimental instrument has a bar code different from that of other instruments. The bar codes on the experimental instruments are scanned into an instrument information database. In this way, even for the experimental instruments with the same type and the same specification, each experimental instrument can be accurately distinguished through the difference in the bar codes. The bar codes of glass instruments have the characteristics of acid and akali resistance, organic solvent resistance and high temperature burning resistance.

After the experiment is arranged in each term, student information like student names of the experiment, student ID, schools and departments, specialties, etc., and experiment teaching information like experimental project, laboratory name of the experiment, experimental time, name list of experiment students, experiment operating desk positions of the students of the experiment, experimental instructors, etc., are also inputted into the system for evaluating experimental course achievement of the students.

The central processing module of the system for evaluating experimental course achievement of the students sends the student information like student names of the experiment, student ID, schools and departments, specialties, etc., and the experiment teaching information like experimental time, name list of experiment students, etc. to the attendance statistic module, sends the student information like student names of the experiment, student ID, schools and departments, specialties, etc., and the experiment teaching information like experimental course name, experimental project, laboratory name of the experiment, experimental time, name list of experiment students, experiment operating desk positions of the students, experimental instructors, etc. to the video monitoring sub-module and the mobile monitoring sub-module, and sends the experimental instrument information like experimental instrument names, bar codes of the instruments, model, specifications, price, manufacturer, etc., the student information like student names of the experiment, student ID, schools and departments, specialties, etc., and the experiment teaching information like experimental course name, experimental project, laboratory name of the experiment, experimental time, name list of experiment students, experiment operating desk positions of the students, experimental instructor, etc. to the instrument management module.

The students need to input the feature identification information required by the attendance statistic module before starting the experiment. The attendance statistic module of the system for evaluating experimental course achievement of the students of the laboratory uses a fingerprint identification technology to identify the student identity. A fingerprint scanner of the attendance statistic module first receives the student information like student names of the experiment, student ID, schools and departments, specialties, etc., and the experiment teaching information like experimental time, name list of experiment students, etc. from the central processing module. The students first find out own names, student ID, schools and departments, and specialties in the fingerprint scanner and then input fingerprint in accordance with the instruction of the scanner until the fingerprint scanner prompts a successful input.

Before starting the whole experimental course, the students need to confirm that their responsible experimental instruments are intact first, and then scan the bar codes on their responsible experimental instruments into the database. The instrument information database associates the students with their responsible experimental instruments to form responsible experimental instrument information in the instrument information database.

The students enter the computer written test module of experimental knowledge through the student interface module. The computer written test module of experimental knowledge randomly extracts examination questions from the objective question examination database comprising choice questions and true or false questions to form examination paper provided to the examination students. The objective question examination database comprising choice questions and true or false questions from which 50 examination questions are randomly extracted to form examination paper provided to the examination students. The examination students answer the examination paper. The computer written test module of experimental knowledge receives the answers of the examination students and compares the same with standard answers, and then provides the answering information of the examination students to the central processing module. Only the qualified students have the qualification to conduct the chemical experiment.

At this point, necessary preparation before starting the whole experimental course is finished.

The work of preparation of test samples can be finished before starting the whole experimental course or before starting the experiment using the test samples.

A label with unique identification code information, having unique number, based on the automatic identification technology is stuck to each test sample. There are at least two test samples with different measured characteristics. Considering from the complexity of preparing the test samples, not more than 15 kinds of samples of different measured characteristics are used.

The label with unique identification code information of each test sample and the information of the measured characteristics of each test sample are inputted into the test sample information database of the system for evaluating experimental course achievement of the students.

The test samples required in the experiment of Determination of Contents of Sodium Hydroxide and Sodium Carbonate in Mixed Alkali are taken as an example to describe how to prepare the test samples: first, preparing two mixed alkali samples with different contents of sodium hydroxide and sodium carbonate, wherein 140 g of sodium hydroxide and 160 g of sodium carbonate are respectively weighed and evenly mixed to obtain a test sample 1, and 190 g of sodium hydroxide and 110 g of sodium carbonate are respectively weighed and evenly mixed to obtain a test sample 2; and then determining by the experimental teacher. The result in sample 1: the content of sodium hydroxide is 46.84% and the content of sodium carbonate is 53.16%, and the result in sample 2: the content of sodium hydroxide is 63.41% and the content of sodium carbonate is 36.59%. The above determination results as standard values of the test samples are inputted into the test sample information database. The sample 1 is subpackaged into 1-gram packets to which the labels with unique identification code information and different numbers are stuck randomly. The labels with unique identification code information are scanned into the test sample information database, and the content of sodium hydroxide and the content of sodium carbonate in the packets are also inputted into the test sample information database. Sample 2 is processed in the same way. Then, all the packets of sample 1 and sample 2 are mixed together and stored for standby.

The test samples required for other experiments are also prepared in the similar method. Correspondingly, the measured characteristic information and the labels with unique identification code information are also inputted into the test sample information database.

Before starting each experiment, the students need to: input fingerprint on the attendance statistic module, receive samples and check experimental instruments.

The students first input fingerprint on the fingerprint scanner. The attendance statistic module compares the time of inputting the feature identification information by the students during the experiment with the time required by the experiment to confirm whether the students are late, and then provides the identification result to the central processing module.

After that, the students receive randomly distributed test samples, and scan the labels with unique identification code information on the received test samples through a bar code scanner. The bar code scanner sends the scanned identification code information of the test samples to the experimental test sample module.

After receiving the identification code information about the test samples sent by students, the experimental test sample module finds the corresponding measured characteristic of the identification code in the test sample information database, and sends the students and the measured characteristics of the received samples to the experimental data processing and analysis module and the central processing module.

Then, the students inspect the experimental instruments. If students find the instruments are damaged in inspection, they need to scan the bar code information of the damaged instruments, provide it to the central processing module, and send the damaged instruments into damaged instrument area; an experimental instrument manager will open the storage position of a new instrument and lead the students to get a new instrument of same type from experimental instrument manager and scan the new bar code to update database; then the experimental instrument manager will identify students who damage the instrument by evidences like experiment arrangement and video monitoring, and inform the related student to compensate by the student interface module.

If the students check and find that the experimental instruments that do not belong to their responsible instruments appear in storage positions of their responsible experimental instruments at the beginning of the experiment, they can confirm the responsible students of the experimental instruments through the bar codes on the experimental instruments and return the misplaced experimental instruments to the related students.

If the students check and find that some of their responsible experimental instruments are missing at the beginning of the experiment compared with their responsible experimental instruments in the information database, they need to wait for other students to scan the bar codes of the experimental instruments and ask whether they find the missing experimental instruments. If the missing experimental instruments are found, the students get them back; and if the missing experimental instruments are not found, the students should provide the bar code information of the missing instruments to the central processing module. Then an experimental instrument manager will open the storage position of a new instrument and lead the students to receive a same type new instrument, scan the bar code of the new instrument for registration and update the information database of the student instrument; after that, the experimental instrument manager confirms the students who damage the instrument according to the experimental information like experimental arrangement and the evidence like video monitoring and notifies the students who damage the instrument in the student interface module to do compensation.

After preparation is finished before each experiment, the students start the experiment.

In the process of the experiment, the instructors use the video monitoring sub-module and the mobile monitoring sub-module to supervise, inspect, evaluate and record students' operation, discipline, sanitation, etc.

The video monitoring sub-module comprises an audio and video collecting device and an audio output device installed in the laboratory, a video display device and an audio input and output device installed in the monitoring room and corresponding software.

The experimental instructors observe student experimental operating situation through the video display device in the monitoring room, and correct students' improper operation in time. The experimental instructors can find whether the students violate provisions of the laboratory through the video collecting device used for observing laboratory overall situation. Through the video collecting device installed on room wall or ceiling of the experimental platform or crossed platform extension lines, the experimental instructors can observe whether the students' operation is correct. The experimental instructors can observe whether the operation of the students is correct through the video collecting devices installed in a public instrument operation region and a public reagent taking region where the operation of the students can be monitored. The experimental instructors can prevent students' problems in the experiment through the audio output device in the laboratory and correct students' misoperation. When the students have improper operation in the process of the experiment, such as experimental operation errors, experimental instrument misuse, etc., the teachers can intercept the screen and store a photograph for standby, then inquire the student information in the position in the central processing module, provide students' problems in the experiment to the central processing module and record the experimental operation evaluation. In addition, through video monitoring, the students can conduct the experiment more carefully.

In order to complete the video monitoring, the position of the experimental operating desk of each student needs to be fixed. When all the students finish filling their experiment position information in a sheet, teachers will count and input the information into the central processing module for recording.

If some experimental instruments are damaged, it can also trace to the responsible person in time. Because the operation video of each experiment can be recorded, it is convenient to confirm the damage condition of common experimental instruments. If the students who damage the common experimental instruments do not admit that, the monitoring video can be invoked as an evidence.

There are two kinds of video collecting devices. One is used to observe the laboratory overall situation, mainly for observing whether violations of laboratory provisions exist in the laboratory. The other is installed in the position where student operation can be observed, mainly used for observing whether the student operation is correct. For this kind of camera, it can be installed on room wall or ceiling of the experimental platform or crossed platform extension lines for monitoring the operation of this row of students or installed in a public instrument operation region and a public reagent taking region for monitoring the operation of the students in the public region.

The balance room of the chemical laboratory has two rows of balances. A camera is arranged above the room wall or ceiling of crossed extension lines on both sides of each row of balances for observing student operation of the balances, and a camera which observes the complete picture of the balance room as much as possible is also arranged.

Six experimental platforms are arranged in the room used for the students to conduct the experiment. Each column of experimental platforms has five experimental operation positions where five students can conduct the experiment. The camera is arranged above the room wall or ceiling of crossed extension lines on both sides of each column of experimental platforms, used for observing the experimental operation of the students. The room used for the students to conduct the experiment has a table balance region for weighing solid reagents and one camera used for observing the balance weighing operation of the students. A fume cupboard used for weighing liquid reagents is arranged in the room used for the students to conduct the experiment. A camera is arranged in the fume cupboard and used for observing the weighing operation of the liquid reagents of the students. A column of side platforms is also arranged in the room used for the students to conduct the experiment and devices like pneumatic dryer are arranged above. A camera is arranged on the room wall or ceiling of crossed extension lines on both sides of the platforms and used for observing related experimental operation of the students. Three water tanks arranged in a straight line are also arranged in the room used for the students to conduct the experiment and have water supply and sewer used for cleaning the experimental instruments. A camera is arranged on the room wall or ceiling of crossed extension lines on both sides of the water tanks and used for observing student operation of cleaning the experimental instruments.

The video monitoring sub-module can store videos shot by the cameras for a period of time, and has inquiry functions like playback and evidence fixing function like image interception.

The mobile monitoring sub-module is installed in the smart phone, storing lab name, experimental course name, experimental project, experimental time, student name and ID according to major and class, experimental instructors and other information; and options like types of student operation error and types of violations of laboratory provisions are arranged in the mobile monitoring sub-module.

When the experimental instructors find students' operation errors or violations of laboratory provisions during patrol in the laboratory through the smart phone provided with the mobile monitoring sub-module carried by the experimental instructors, student's name and ID are confirmed in the mobile monitoring sub-module at first, and then corresponding options like types of student operation error and types of violations of laboratory provisions are chose to identify. Finally, the mobile monitoring sub-module provides the identification of types of student operation error and types of violations of laboratory provisions to the central processing module by wireless way.

The experimental instructors can also use the mobile monitoring sub module to take a photograph for misoperation of the students and send the photograph into a CPU as an evidence. Then, the teachers remind and help the students to correct misoperation of the experiment and confirm student's name and ID, and then, choose corresponding options like types of student operation error and types of violations of laboratory provisions to identify. Finally, the mobile monitoring sub-module provides the identification of types of student operation error and types of violations of laboratory provisions to the central processing module by wireless way.

After reading the original data of the experiment, the students use the image collecting device to shoot an image of the original data of the experiment and then use the image transmission device to transmit the data to the image identification software. The image identification software reads and provides the original data of the experiment in the image by an image identification method to the experimental data processing and analysis module and the central processing module.

For example, after titration, a titration level is shot and sent to the mage identification software for identifying the position of a scale line and reading titration volume.

The original data of the experiment read by the image identification way is compared with students' experimental data and analyzed so as to inspect whether students' original data of the experiment is real and prevent the students from modifying the original data or plagiarizing others' data.

When the students use an instrument with a data communication interface capable of transmitting the determination data into the computer, the experimental data input interface module receives students' experimental data transmitted by the experimental instrument data communication interface, and then provides the data to the experimental data processing and analysis module and the central processing module. For example, an electronic balance is essentially equipped with an RS232 data communication interface. After a substance is weighed by the students, the experimental data of weighing the mass can be directly transmitted from the electronic balance. The experimental data input interface module receives student weighing data transmitted from the data communication interface of the electronic balance and provides the same to the central processing module.

After the students finish the experiment, they need to clean the experimental instruments and put their responsible experimental instruments on normal storing areas, and scan the bar codes again in order to confirm that their responsible experimental instruments are not missing and misplaced.

At the end of the experiment, the students need to clean the laboratory and clean the experimental platform surfaces used by individual experiments. The intructors shall sign on the original experimental data of the students and after that, the students need to scan the fingerprint in the fingerprint scanner again to confirm the time of leaving the laboratory.

Students on duty are responsible for cleaning public regions and arranging experimental instruments and reagents, and also need to inspect and confirm whether common instruments are intact or not. If some instruments are damaged, it shall be reported to the teachers in time for processing. If the responsible person can be found through the video monitoring system, the responsible person makes compensation; otherwise, the whole class makes compensation collectively.

After the above work is finished, the instructors carry the mobile monitoring sub-module to inspect the cleaning condition of the students and make corresponding identification according to different conditions.

Students can input experimental data read by the students themselves and their processed results through the student interface module, and need to autonomously input the data after the experiment. After the experiment, students can enter the data input interface of the data analysis system and input corresponding original data into the input interface. The data is automatically stored and transmitted to the central processing module. Students can browse related experimental information like their experimental achievement, deduction, instrument compensation, etc. through the student interface module, and class management personnel such as monitor can browse and manage cleaning duties, laboratory discipline, instruments compensation and other related information of the class. At the end of the course, the class management personnel collect all the compensation payments for damaged instruments of all the students in the class and give the experimental instructors.

At the end of the students' experiment, corresponding data processing shall be made to form an experimental result for writing an experimental report. In the next experiment, experimental reports are collected by a subject representative and given to the teacher. The teacher gives the students corresponding experimental report scores according to such standards as integrity of the experimental reports of the students. The experimental report achievement reviewed by the experimental instructor is provided to the central processing module through the teacher interface module.

The attendance statistic module of the students detects the fingerprint of designated fingers on the fingerprint scanner before and after each experiment of the students and sends the detection information about the student fingerprint to the central processing module. The central processing module receives student fingerprint information, checks the identity information of the students, and also records the time of initial fingerprint detection of the students. In fingerprint scanning, the central processing module can be connected on-line for information check. Alternatively, the fingerprint is stored off-line, and then data is exported through a USB interface and stored into the central processing module of a terminal.

In fingerprint identification after the experiment, the fingerprint detection time shall be recorded again while checking the above information, and a differencing operation is made between the fingerprint detection time and the initial detection time for recording the experimental time of the students. If students have no attendance time twice, they are regarded as absence from duty; if the initial fingerprint identification time of the students is later than school time, the students are regarded as lateness; and if the second fingerprint identification time is earlier than class-over time, the students are regarded as early leaving.

The experimental data processing and analysis module receives students' experimental original data identified in an image identification way, students' experimental data transmitted from the experimental instrument data output interface, the test sample information provided by the experimental test sample module, experimental data read by the students themselves and calculating results.

The experimental data processing and analysis module compares the received students' experimental original data identified in the image identification way, students' experimental data transmitted from the experimental instrument data output interface and the experimental data read by the students themselves to evaluate the accurate situation of reading the original data by the students.

The experimental data processing and analysis module compares the received test sample information provided by the experimental test sample module with the calculation result of the students to evaluate the accurate situation of the test results of the students.

The experimental data processing and analysis module integrates the accurate situation of reading the original data by the students and the accurate situation of the test results of the students and forms the entire situation of the experimental data of the students and provides the same to the central processing module.

The experimental data processing and analysis module analyzes the accuracy or/and precision of the students' experimental original data identified in the image identification way, students' experimental data transmitted from the experimental instrument data output interface and the experimental data read by the students themselves in accordance with the data processing and analysis requirements of an experiment teaching material, and provides the accuracy or/and precision analysis result to the central processing module.

The central processing module converts the received attendance information of experimental students, students' experimental situations found by the video monitoring sub-module, students' related situations found by the mobile monitoring sub-module during patrol, experimental instrument related situations, the overall situation of students' experimental data, students experimental knowledge test achievement and experimental report results reviewed by the experimental instructors into the corresponding attendance achievement, video achievement, patrol achievement, instrument achievement, data achievement, examination achievement and report achievement in accordance with pre-established criteria.

In the analytical chemistry laboratory, each experiment has a full score of 100, wherein attendance achievement, video achievement, patrol achievement, instrument achievement, data achievement and report achievement respectively have weights of 10 scores, 10 scores, 10 scores, 10 scores, 40 scores and 20 scores.

5 scores are deducted for lateness and early leaving; 10 scores are deducted for absenteeism and lateness for more than 10 minutes and penalty run is needed; 2 scores are deducted for each experimental operation error: 2 scores are deducted for each violation of laboratory discipline; 3 scores are deducted for each damaged or missing experimental instrument; and the data achievement calculated and given by the program is between 30 scores and 40 scores.

The types of the experimental operation errors include the operation errors of common experimental instruments like balances, piettes, volumetric flasks, burettes, measuring cylinders, etc. For example, the weighing of the analytical balance comprises the key operation steps of inspecting the balance level, adjusting the balance zero, closing the balance door at any time, horizontally opening the dryer, taking a strip of paper out of a weighing bottle, placing the weighing bottle in the center of the tray, knocking the upper edge of the weighing bottle, raising the weighing bottle while knocking, ensuring that drugs have no leakage and surplus, returning the weighing bottle to the dryer, returning the balance to zero, recovering excessive samples, putting the strip of paper into a dustbin, not changing a data record, etc. Violations of the above operation requirements will be regarded as experimental operation errors and deduction will be made.

Types of violations of experimental discipline include behavior errors, which endanger laboratory safety and influence laboratory sanitation, like slapstick, eating, speaking loudly, littering, etc. in the laboratory.

The experimental instructors add the experimental achievement of each experiment and the examination achievement in accordance with certain weights to obtain the final experimental achievement of the students, and submit the same to an educational administration system of the school for incorporation in students' achievement file.

The above is just one concrete embodiment of the present invention, but the protection scope of the present invention is not limited thereto. Any change or replacement contemplated easily by those skilled in the art familiar with the technical field within the technical scope disclosed by the present invention shall be covered within the protection scope of the present invention.

We claim:

1. A system and method for evaluating experiment teaching achievement based on automatic identification technology, characterized in that:
The system comprises an attendance statistic module, a monitoring module which includes a video monitoring sub-module and a mobile monitoring sub-module, an instrument management module, an experimental data and image identification module, an experimental data input interface module, an experimental test sample module, an experimental data processing and analysis module, an computer written test module of experimental knowledge, a student interface module, a teacher interface module, a central processing module and the like.
The attendance statistic module is used to provide the attendance information of students to the central processing module.
Experimental instructors will provide students' experimental conditions found by the video monitoring sub-module to the central processing module.
By the mobile monitoring sub-module, experimental instructors will provide students' relevant conditions found in patrol to the central processing module.
The instrument management module is used to provide relevant instrument condition records including usage, loss, damage, compensation and so on to the central processing module.
The experimental data and image identification module is used to identify students' original data in image identification way and provide these information to the experimental data processing and analysis module and the central processing module.
The experimental data input interface module is used to receive students' experimental data transmitted by the experimental instrument data communication interface, and then provide these information to the experimental data processing and analysis module and the central processing module.
The experimental test sample module is used to manage test samples and relevant information, record sample allocation and provide students' sample information to the experimental data processing and analysis module and the central processing module;
The experimental data processing and analysis module is used to analyze and process the students' experimental original data identified in image identification way, students' experimental data transmitted from the experimental instrument data output interface, the test sample information provided by the experimental test sample module, experimental data read by the students themselves and calculating results, and provides related conditions of the experimental data of the students to the central processing module.
The computer written test module of experimental knowledge is used to test students about experimental knowledge by computer exam system, and then provide exam results to the central processing module.
Experimental instructors can mark students' experimental reports, and then provide students' scores to the central processing module through the teacher interface module.
Students can input experimental data and results analyzed and calculated by the students themselves through the interface module, and can also browse their experiment scores, deduction, compensation records of experimental instruments and related information. Students need to participate in experimental knowledge examination by the student interface module.
Class management personnel such as monitor and instruments manager can browse and manage cleaning duties, laboratory discipline, instruments compensation and other related information.
The central processing module stores a variety of information required for normal operation of each module like the attendance statistic module, the monitoring module, instrument management module, the experimental data and image identification module, the experimental data input interface module, the experimental test sample module, the experimental data processing and analysis module, the computer written examination module of experimental knowledge, the student interface module and the teacher interface module, and provides the required information to each module.
The central processing module converts the received attendance information of experimental students, students' experimental situations found by the video monitoring sub-module, students' related situations found by the mobile monitoring sub-module during patrol, experimental instrument related situations, the overall situation of students' experimental data, students experimental knowledge test achievement and experimental report results reviewed by the experimental instructors into the corresponding attendance achievement, video achievement, patrol achievement, instrument achievement, data achievement, examination achievement and report achievement in accordance with pre-established criteria.
The final experiment scores of students are obtained by weighted adding attendance scores, performance scores, video scores, patrol scores, instrument scores, data scores, exam scores and report scores according to the predetermined methods.

2. The system and method for evaluating experiment teaching achievement based on automatic identification technology according to claim 1, characterized in that:
The central processing module stores
laboratory information like laboratory name, laboratory type, laboratory location, teachers responsible for laboratory etc.
teacher information like teachers' names and positions, etc.
experimental device information like device name, number, model, specifications, use, price, purchase date, manufacturer, belonging laboratory and responsible teachers, etc.
experimental instrument information like experimental instrument names, bar codes, model, specifications, price, manufacturer, etc,
data like objective question database and related test data,
student name, student number, department, major and other student information
experimental course name, experimental project, experiment lab name, experiment time, name list of students, experimental instructor, student experimental operation table location and other teaching infonmation
test samples information,
student achievement information
The central processing module is responsible for storing these information and distributing these data to those which need corresponding information like the attendance statistic module, the monitoring module, the instrument management module, the experimental data and image identification module, the experimental data input interface module, the experimental test sample module, the experimental data processing and analysis module, the computer written examination module of experimental knowledge, the student interface module and the teacher interface module.

3. The system and method for evaluating experiment teaching achievement based on automatic identification technology according to claim 1, characterized in that:
The automatic identification technology includes bar code technology, two-dimension code technology, magnetic stripe technology, IC card technology, radio-frequency technology, biological feature identification technology and so on;
During experiment teaching, each student, experimental instrument, and test sample will be given a combined code based on automatic identification technology. Through combined code reading devices, combined code can be identified each experimental student, experimental instrument and test sample. Besides, students can also be identified by biological characteristics;
Wherein the feature combined code can use bar code, two-dimensional code, magnetic stripe, IC card or radio-frequency chip as carries,
Correspondingly, combined code reading devices are bar code scanner, two-dimensional code scanner, magnetic stripe reader, IC card reader, radio-frequency label reader and so on;
More specifically,
Students can use any one kind of bar code technology, two-dimensional code technology, magnetic stripe technology, IC card technology, radio-frequency technology, biological feature identification technology to be identified;
Bar codes are used to identify experimental instruments;
Test samples can use any one kind of bar code technology, two-dimensional code technology, magnetic stripe technology, IC card technology or radio-frequency technology to be identified.

4. The system and method for evaluating experiment teaching achievement based on automatic identification technology according to claim 1, characterized in that
Wherein the attendance statistic module uses one car more kinds of fingerprint identification technology, face identification technology, iris identification technology, retina identification technique, corneal identification technology, voice identification technology to identify students;
Wherein the attendance statistic module is used to memorize feature identification information of each student at first, such as fingerprint, face, iris, retina, cornea, voice and so on, then establish unique association of these feature identification information and students' identity;
Students need to input feature identification information at the beginning and the end of the experiment, and the attendance statistic module compares the time of inputting the feature identification information by the students during the experiment with the time required by the experiment to confirm whether the students are late, leaving early or absent, and provides the identified result to a central processing module.

5. The system and method for evaluating experiment teaching achievement based on automatic identification technology according to claim 1, characterized in that:
Wherein the monitoring module comprises video monitoring sub-module and the mobile monitoring sub-module
Wherein the video monitoring sub-module comprises an audio and video collecting device and an audio output device installed in the laboratory, a video display device and an audio input and output device installed in the monitoring room and corresponding software;
The experimental instructors observe student experimental operating situation through video display. Besides, they can observe laboratory overall situation to find whether students violate provisions of the laboratory through the video collecting device installed in the experimental platform. Through the video collecting device installed in the experimental platform or platform extension line, teachers can observe whether the operation of students is correct. And experiment instructors can observe whether the use of public instruments and taking public reagent operation are correct through monitoring video devices installed in the public instrument operation area and reagent supply area;
Experimental instructors can point out students' problems in experiment through the audio output device in the laboratory, and provide problems found in experiment to the central processing module;
The mobile monitoring sub-module is installed in the smart phone, storing lab name, experimental course name, experimental project, experimental time, student name and ID according to major and class, experimental instructors and other information; options like types of student operation error and types of violations of laboratory provisions are arranged in the mobile monitoring sub-module.
When teachers find students operation error or violations of laboratory provisions in the patrol during experiment, student's name and ID are confirmed in the mobile monitoring sub-module at first, and corresponding options like types of student operation error and types of violations of laboratory provisions are chose to be identify. Finally, the mobile monitoring sub-module provides the identification of types of student operation error and types of violations of laboratory provisions to the central processing module by wireless way.
After laboratory cleaning, experimental instructors check sanitation situation and deduct marks for those students on duty who fail to meet cleaning requirements, and then provide related information to the central processing module.

6. The system and method for evaluating experiment teaching achievement based on automatic identification technology according to claim 1, characterized in that:
The instrument management module is responsible for the statistics of instrument usage, loss, damage, compensation, and provides related information to the central processing module.
The hardware of the instrument management module includes a bar code scanner and experimental instruments with bar codes. The bar code on each experimental instrument is not the same;
Before experimental course, students will initially confirm whether the instruments is in good condition, then scan bar codes on the instruments into database, so information that the student is responsible for the instrument is stored into the database. Students scan bar codes on their responsible experiment instruments before each experiment and compared with information in the database in order to confirm experiment instruments are in good condition;
If students find instrument is damaged in inspection at the beginning of the experiment, they need to scan damaged instrument bar code and provide it to the central processing module, damaged instruments should be stored into damaged instrument area; an experimental instrument manager will open the storage position of a new instrument and lead the students to get a new instrument of same type from experimental instrument manager and scan the new bar code to update database; then the experimental instrument manager will identify students who damage the instrument by evidences like experiment arrangement and video monitoring, and inform the related student to compensate by the student interface module.
If the students check and find that the experimental instruments that do not belong to their responsible instruments appear in storage positions of their responsible experimental instruments at the beginning of the experiment, they can confirm the responsible students of the experimental instruments through the bar codes on the experimental instruments and return the misplaced experimental struments to the related students.
If the students check and find that some of their responsible experimental instruments are missing at the beginning of the experiment compared with their responsible experimental instruments in the information database, they need to wait for other students to scan the bar codes of the experimental instruments and ask whether they find the missing experimental instruments. If the missing experimental instruments are found, the students get them back; and if the missing experimental instruments are not found, the students should provide the bar code information of the missing instruments to the central processing module. Then an experimental instrument manager will open the storage position of a new instrument and lead the students to receive a same type new instrument, scan the bar code of the new instrument for registration and update the information database of the student instrument; after that, the experimental instrument manager confirms the students who damage the instrument according to the experimental information like expenmental arrangement and the evidence like video monitoring and notifies the students who damage the instrument in the student interface module to do compensation.
If the students damage the experimental instrument in the experiment, they need to scan and provide the bar code information of the damaged instruments to the central processing module and store the damaged instrument to the damaged instrument area; the experimental instrument manager will open the storage position of a new instrument and lead the students to get a new instrument of same type, scan the bar code of the new instrument for registration and update the information database of the student instrument; after that, the experimental instrument manager confirms the students who damage the instrument and notifies the students who damage the instrument in the student interface module to do compensation.
If the students damage the experimental instrument and the bar code at the same time, they need to manually input the information related to the instrument, provide the information of the damaged instrument to the central processing module and store the damaged instrument to the damaged instrument area. The experimental instrument manager will open the storage position of a new instrument and lead the students to get a new instrument of same type, scan the bar code of the new instrument for registration and update the information database of the student instrument; after that, the experimental instrument manager confirms the students who damage the instrument and notifies the students who damage the instrument in the student interface module to do compensation.
After the experiment, the students need to put their responsible experimental instruments on normal storing areas, and scan the bar codes again in order to confirm that their responsible experimental instruments are not missing and misplaced.
The instrument management module automatically calculates out the compensation amount of each student as damage of the experimental instruments and sends the compensation amount to the central processing module. The central processing module sends the amount information to be compensated for each student due to damage of the experimental instruments to the student interface module of the students, and meanwhile makes a copy for the experimental instrument manager of the class of the student. Finally, the experimental instrument manager of the class should collect all the compensation fees of the experimental instruments of the whole experimental class and turn over money to experimental instructors.

7. The system and method for evaluating experiment teaching achievement based on automatic identification technology according to claim 1, characterized in that:
The experimental data and image identification module comprises an image collecting device, an image transmission device and image identification software;
After reading the original data of the experiment, the students use the image collecting device to shoot an image of the original data of the experiment and then use the image transmission device to transmit the data to the image identification software. The image identification software reads and provides the original data of the experiment in the image by an image identification method to the experimental data processing and analysis module and the central processing module.
The experimental data input interface module receives students' experimental data transmitted by the experimental instrument data communication interface, and then provides the data to the experimental data processing and analysis module and the central processing module.

8. The system and method for evaluating experiment teaching achievement based on automatic identification technology according to claim 1, characterized in that:
The experimental test sample module comprises a test sample, a test sample information database, etc.
Each experiment has 2 to 15 test samples which have significant difference in measured quantitative characteristics.
Each test sample is made into an independently packed test sample applicable to each student or experimental group, and an information carrier in which feature combined codes are stored is adhered to the test sample or the package of the test sample. The quantitative characteristic value of each test sample and the corresponding feature combined code information are inputted into a sample information database and associated.
The students get test samples before the experiment and scan the received carrier in which the feature combined code information is stored on the test samples through a feature combined code information reading device. The feature combined code information reading device sends the scanned feature combined code information of the test samples to the experimental test sample module.
After receiving the feature combined code information about the test samples sent by students, the experimental test sample module finds the corresponding measured characteristic of the feature combined code information in the test sample information database, associates the students with the standard values of the measured quantitative characteristics of the received test samples, and then sends the conditions to the experimental data processing and analysis module and the central processing module.

9. The system and method for evaluating experiment teaching achievement based on automatic identification technology according to claim 1, characterized in that:
The experimental data processing and analysis module receives students' experimental original data identified in an image identification way, students' experimental data transmitted from the experimental instrument data output interface, the test sample information provided by the experimental test sample module, experimental data read by the students themselves and calculating results.
The experimental data processing and analysis module compares the received students' experimental original data identified in the image identification way, students' experimental data transmitted from the experimental instrument data output interface and the experimental data read by the students themselves to evaluate the accurate situation of reading the original data by the students.
The experimental data processing and analysis module compares the received test sample information provided by the experimental test sample module with the calculation result of the students to evaluate the accurate situation of the test results of the students.
The experimental data processing and analysis module integrates the accurate situation of reading the original data by the students and the accurate situation of the test results of the students and forms the entire situation of the experimental data of the students and provides the same to the central processing module.
The experimental data processing and analysis module analyzes the accuracy or/and precision of the students' experimental original data identified in the image identification way, students' experimental data transmitted from the experimental instrument data output interface and the experimental data read by the students themselves in accordance with the data processing and analysis requirements of an experiment teaching material, and provides the accuracy or/and precision analysis result to the central processing module.

10. The system and method for evaluating experiment teaching achievement based on automatic identification technology according to claim 1, characterized in that:
The computer written test module of experiments knowledge tests the students about experimental knowledge by the computer exam system, and then provides exam results to the central processing module.
The computer written test module of experimental knowledge comprises an objective question examination database of each experimental course that comprises choice questions and true or false questions provided in the laboratory.
The students enter the computer written test module of experimental knowledge through the student interface module. The computer written test module of experimental knowledge randomly extracts examination questions from the objective question examination database of the experimental course of the students to form examination paper provided to the examination students. The examination students answer the examination paper. The computer written test module of experimental knowledge receives the answers of the examination students and compares the same with standard answers, and then provides the answering information of the examination students to the central processing module.
